(19) United States
(12) Patent Application Publication
(10) Pub. No.: US 2024/0001358 A1
(43) Pub. Date: Jan. 4, 2024

(54) DIAGNOSTIC PHOTONIC BIOSENSOR METHODS, APPARATUS, AND SYSTEM

(71) Applicants: Ortho-Clinical Diagnostics, Inc., Raritan, NJ (US); The Research Foundation for the State University of New York, Albany, NY (US); University of Rochester, Rochester, NY (US)

(72) Inventors: Raymond F. Jakubowicz, Rush, NY (US); Harold Warren, Rush, NY (US); Benjamin Miller, Rochester, NY (US); Michael Bryan, Rochester, NY (US); Daniel Steiner, Rochester, NY (US); John Cognetti, Rochester, NY (US); Nathaniel Cady, Delmar, NY (US); Minhaz Abedin, Jamaica, NY (US); Natalya Tokranova, Cohoes, NY (US)

(21) Appl. No.: 17/585,914

(22) Filed: Jan. 27, 2022

Related U.S. Application Data
(60) Provisional application No. 63/143,452, filed on Jan. 29, 2021.

(51) Int. Cl. B01L 3/00; G02B 6/42; G02B 6/293

(52) U.S. Cl. CPC B01L 3/502715; G02B 6/4215; G02B 6/29305; G02B 6/4262; B01L 2300/0654; B01L 2300/0816

(57) ABSTRACT

An apparatus, methods, and a system for a photonic biosensor are disclosed. The photonic biosensor includes a substrate having a sample addition zone in fluid communication with a wicking zone and a sample detection zone. The substrate also includes an optical input port configured to optically couple to a light source and an optical output port configured to optically couple to a light detector. The photonic biosensor also includes a photonic integrated circuit (“PIC”) connected to the substrate. The PIC includes a first grating coupler aligned with the optical input port, a second grating coupler aligned with the optical output port, at least one waveguide between the first grating coupler and the second grating coupler, and at least one detection element disposed within the at least one waveguide.

### PRIORITY CLAIM

This application claims priority to and the benefit as a non-provisional application of U.S. Provisional Patent Application No. 63/143,452, filed Jan. 29, 2021, the entire contents of which are hereby incorporated by reference and relied upon.

### STATEMENT REGARDING FEDERALLY SPONSORED RESEARCH OR DEVELOPMENT

This invention was made with government support under contract number FA8650-15-2-5220 awarded by the United States Department of Defense. The government has certain rights in the invention.

### BACKGROUND

The use of photonic biosensors to measure refractive light index changes in a sample is well known. The detected change in refractive light of a sample provides for the detection of analytes. Some known optical structures of a biosensor cause a refractive index change as a result of binding of an analyte to an optical surface and/or reagent, which creates a detectable change in an optical resonance frequency. These known biosensors provide high sensitivity and label free detection of desired analytes.

Typically, detection elements of biosensors are created on silicon substrates using traditional silicon-based nanoscale manufacturing processes, such as complementary metal-oxide-semiconductor (“CMOS”) fabrication processes. The use of silicon-based fabrication processes creates biosensor detection elements for integrated photonics that have exceptional optical and biochemical characteristics. For example, silicon-based fabrication processes enable precise and/or intricate optical structures of a detection element to be manufactured in silicon or silicon nitride. The optical structures include, for instance, ring resonators, spiral waveguides, grating couplers, and Mach-Zehnder Interferometers (“MZI”). These structures generally require near defect-free optical paths to ensure results are not affected by material impurities or structural defects.

While silicon-based processes provide precise biosensor detection elements on a substrate, known biosensors typically have costly fluid and light interconnections. For example, optical fiber bonding of input and output optics is typically needed for interfacing with light paths of a detection element. Further, many biosensors have complex active fluid delivery mechanisms to bring a sample into contact with the detection element. Oftentimes, a fluid sample is pulled or pushed to a detection element using external pumps that control sample volume and flow rate through the biosensor. This light and fluid interconnect complexity increases the cost of instrumentation, and the biosensors themselves. While the increased cost may be acceptable for some medical applications, generally point-of-care (“PoC”) and mainframe laboratory diagnostic applications are cost sensitive, especially for disposable products such as single-use biosensor slides, cartridges, or cassettes.

### SUMMARY

Diagnostic photonic biosensor methods, apparatus, and systems are disclosed herein. The example methods, apparatus, and systems provide a photonic biosensor that includes a microfluidic slide, test card, or cassette. The photonic biosensor also includes at least one photonic integrated circuit (“PIC”) having a detection element that is connected to a fluid pathway provided on a slide, test card, or cassette. The example slide, test card, or cassette also includes an area for receiving a sample, where the fluid pathway uses wicking or capillary action (or other passive microfluidic transport structure) to passively pull a sample into contact with the detection element. Additionally, the slide, test card, or cassette includes optical ports for optically coupling with a light source and a light detector of a laboratory analyzer, PoC device, or other analyte analysis device.

During use, in an example embodiment, a sample is applied to a receiving area surface of the slide or cassette. A fluid pathway includes a passive microfluidic transport that causes the applied sample to flow to a detection zone and wicking zone. The detection zone includes a silicon-based PIC having a functionalized detection element. In some embodiments, the detection element of the PIC is functionalized with one or more types of capture molecules. Light is applied by a light source of an instrument to an input light port of the slide or cassette, which directs the light through the PIC and the detection element. An output light port of the slide or cassette receives the light after passing through the detection element. Contact between the functionalized detection element and the fluid sample causes refractive light index changes, which are detected by a light detector or photosensor of the instrument. The degree of the refractive light index change is indicative of the presence of one or more analytes and/or a concentration of one or more analytes.

The use of passive fluid sample components and a contactless light interface significantly reduces the cost of the biosensor slide or cassette compared to known biosensors with active fluid sample control and light interfaces. Further, the use of a silicon-based PIC provides high precision immunoassay diagnostics while using the available production scale of traditional silicon foundry manufacturing. Further, the disclosed biosensor slide or cassette with integrated PIC(s) enables the multiplexing of assays (e.g., panel testing) to further reduce cost, size, and waste.

In light of the disclosure herein and without limiting the disclosure in any way, in a first aspect of the present disclosure, which may be combined with any other aspect listed herein unless specified otherwise, a photonic biosensor apparatus includes a substrate having a sample addition zone, a wicking zone, and a detection zone located between the sample addition zone and the wicking zone. The substrate also includes a fluid pathway that fluidly couples (e.g., in fluid communication with) the sample addition zone, the detection zone, and the wicking zone, an optical input port located at a section of the sample detection zone and configured to optically couple to a light source, and an optical output port located at the section of the sample detection zone and configured to optically couple to a light detector. The photonic biosensor apparatus also includes a photonic integrated circuit connected to the substrate at the section of the sample detection zone. The photonic integrated circuit includes a first grating coupler aligned with the optical input port, a second grating coupler aligned with the optical output port, at least one waveguide between the first grating coupler and the second grating coupler, and at least one detection element provided along the at least one waveguide and positioned to contact fluid sample within the fluid pathway at the section of the sample detection zone.

In accordance with a second aspect of the present disclosure, which may be used in combination with any other aspect listed herein unless stated otherwise, the at least one detection element includes at least one of a ring resonator, a double ring resonator, a cylindrical resonator, a spherical resonator, a spiral waveguide, a photonic crystal, or a Mach-Zehnder Interferometer (“MZI”).

In accordance with a third aspect of the present disclosure, which may be used in combination with any other aspect listed herein unless stated otherwise, the at least one waveguide includes a silicon nitride waveguide.

In accordance with a fourth aspect of the present disclosure, which may be used in combination with any other aspect listed herein unless stated otherwise, the photonic integrated circuit has a rectangular prism or cuboid shape.

In accordance with a fifth aspect of the present disclosure, which may be used in combination with any other aspect listed herein unless stated otherwise, the first grating coupler is provided at a first side of a face of the photonic integrated circuit, the second grating coupler is provided at a second, opposing side of the same face of the photonic integrated circuit, and the at least one detection element is positioned between the first side and the second side.

In accordance with a sixth aspect of the present disclosure, which may be used in combination with any other aspect listed herein unless stated otherwise, the photonic integrated circuit has a length between 2-20 millimeters (“mm”), a width between 0.25-10 mm, and a height between 0.1-5 mm.

In accordance with a seventh aspect of the present disclosure, which may be used in combination with any other aspect listed herein unless stated otherwise, the substrate includes an enhancer zone or a conjugate zone between the detection zone and the sample addition zone along the fluid pathway, the enhancer zone or the conjugate zone includes at least one reagent for binding with the fluid sample.

In accordance with an eighth aspect of the present disclosure, which may be used in combination with any other aspect listed herein unless stated otherwise, the optical input port includes a first tunnel through the substrate and the optical output port includes a second tunnel through the substrate.

In accordance with a ninth aspect of the present disclosure, which may be used in combination with any other aspect listed herein unless stated otherwise, the first tunnel is located on a first side of a fluid pathway in the sample detection zone and the second tunnel is located on an opposite, second side of the fluid pathway in the sample detection zone.

In accordance with a tenth aspect of the present disclosure, which may be used in combination with any other aspect listed herein unless stated otherwise, the substrate includes at least one of a cassette, a slide, or a test card.

In accordance with an eleventh aspect of the present disclosure, which may be used in combination with any other aspect listed herein unless stated otherwise, the light source and the photodetector are included within a read head of at least one of a laboratory analyzer or a point-of-care (“Port”) analyzer.

In accordance with a twelfth aspect of the present disclosure, which may be used in combination with any other aspect listed herein unless stated otherwise, at least some of the fluid pathway includes micropillars or projections that are substantially vertical to the surface of the substrate and having a height, diameter, and reciprocal spacing such that lateral capillary flow of the fluid sample is achieved.

In accordance with a thirteenth aspect of the present disclosure, which may be used in combination with any other aspect listed herein unless stated otherwise, the height is between 1-1000 μm, the diameter is between 10-100 μm, and the reciprocal spacing is between 5-100 μm.

In accordance with a fourteenth aspect of the present disclosure, which may be used in combination with any other aspect listed herein unless stated otherwise, the detection zone is configured to provide at least one of fluorescence or colorimetric detection of one or more analytes within the fluid sample.

In accordance with a fifteenth aspect of the present disclosure, which may be used in combination with any other aspect listed herein unless stated otherwise, the photonic integrated circuit is connected to the substrate using at least one of a UV curable adhesive, physical stacking, or a tape/glue application.

In accordance with a sixteenth aspect of the present disclosure, which may be used in combination with any other aspect listed herein unless stated otherwise, the optical input port is a first optical input port, the optical output port is a first optical output port, the section is a first section, and the photonic integrated circuit is a first photonic integrated circuit, and wherein the substrate further includes a second optical input port located at a second section of the sample detection zone and configured to optically couple to the light source, and a second optical output port located at the second section of the sample detection zone and configured to optically couple to the light detector.

In accordance with a seventeenth aspect of the present disclosure, which may be used in combination with any other aspect listed herein unless stated otherwise, the apparatus further comprises a second photonic integrated circuit connected to the substrate at the second section, the second photonic integrated circuit including a first grating coupler aligned with the second optical input port, a second grating coupler aligned with the second optical output port, at least one waveguide between the first grating coupler and the second grating coupler, and at least one detection element provided along the at least one waveguide and positioned to contact fluid sample within the fluid pathway at the second section.

In accordance with an eighteenth aspect of the present disclosure, which may be used in combination with any other aspect listed herein unless stated otherwise, the at least one detection element of the first photonic integrated circuit is configured for the detection of a first analyte and the at least one detection element of the second photonic integrated circuit is configured for the detection of a second analyte.

In a nineteenth aspect of the present disclosure, any of the structure, functionality, and alternatives disclosed in connection with any one or more of FIGS. 1 to 16 may be combined with any other structure, functionality, and alternatives disclosed in connection with any other one or more of FIGS. 1 to 16.

In light of the present disclosure and the above aspects, it is therefore an advantage of the present disclosure to provide a photonic biosensor with passive flow components and non-contact light coupling.

It is another advantage of the present disclosure to provide a relatively inexpensive photonic biosensor for PoC applications and mainframe laboratory applications.

It is a further advantage of the present disclosure to provide a photonic biosensor that provides for multiplex assays on a single cassette, test card, or slide.

It is still a further advantage of the present disclosure to provide a photonic sensor with fluorescence or colorimetric detection on a single cassette, test card, or slide.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1A is a diagram of a photonic biosensor including a substrate (slide, test card, or cassette) and a PIC, according to an example embodiment of the present disclosure.

FIG. 1B is a diagram of another photonic biosensor including a substrate (slide, test card, or cassette) and a PIC, according to an example embodiment of the present disclosure.

FIGS. 2A and 2B show a cut-away of the substrate of FIG. 1A or 1B at a section of a sample detection zone that includes an optical input port and an optical output port, according to an example embodiment of the present disclosure.

FIGS. 3A and 3B are diagrams of example PICs of the photonic biosensor of FIGS. 1A and 1B, according to example embodiments of the present disclosure.

FIGS. 4A and 4B show diagrams of alternative embodiments of the PICs of FIGS. 3A and 3B, according to example embodiments of the present disclosure.

FIG. 5 is a diagram of alternative embodiments of the substrate and the PICs, according to example embodiments of the present disclosure.

FIG. 6A is a diagram of a procedure for manufacturing the photonic biosensor of FIG. 1A or 1B, according to an example embodiment of the present disclosure.

FIG. 6B is a diagram illustrative of an example process to form the substrate of FIG. 1A or 1B using injection molding, according to an example embodiment of the present disclosure.

FIGS. 7 to 9B show diagrams of laboratory instrumentation that may be used in conjunction with the photonic biosensor of FIGS. 1A and 1B, according to an example embodiment of the present disclosure.

FIG. 10 is a diagram of example response curves of the PIC of the photonic biosensor of FIGS. 1A and 1B, according to an example embodiment of the present disclosure.

FIG. 11 is a diagram of an embodiment showing features of the photonic biosensor of FIG. 1A or 1B that enable laboratory instrumentation to relatively quickly optically couple with the PIC, according to an example embodiment of the present disclosure.

FIG. 12 is a diagram of an example micropillar layout for a fluid flow path of the biosensor of FIGS. 1A and 1B, according to an example embodiment of the present disclosure.

FIGS. 13 to 16 are diagrams illustrative of analyses performed to measure SARS-CoV-2 antibodies in patient samples using the photonic biosensor of FIGS. 1 to 12, according to an example embodiment of the present disclosure.

### DETAILED DESCRIPTION

Disclosed herein are apparatus, systems, and methods for a low-cost photonic biosensor that provides high performance for immunoassay diagnostics. The example biosensor disclosed herein uses silicon based photonic integrated circuits (“PICs) in conjunction with a substrate that provides for non-contact optical coupling and passive flow mechanisms. One or more PICs are placed on a substrate, which enables the detection of one or more analytes in a fluid sample. Multiple assays may be placed on a substrate for multiplex assays. Additionally or alternatively, the substrate may also provide for fluorescence and/or colorimetric detection in conjunction with the refractive light detection provided by the PIC to provide further analyte characterization capabilities.

The current state of the art for traditional heterogeneous immunoassay diagnostics is based on technologies such as immunofluorescence or chemi-luminescence detection in either solid phase or magnetic particle formats. Though cost has been reduced over the years for reagents, the management of complex automated test procedures (including multiple process steps, precise sample and reagent additions, long/variable assay specific incubation times, tight incubation temperature tolerances, multiple/complex wash protocols, and the use of special signal generating reagents), has led to the development of extremely expensive laboratory instrumentation. Additionally, this complexity leads to higher service rates and expensive operating costs (for labor, consumable expense, waste, and/or power utilization).

In contrast to traditional heterogeneous immunoassay diagnostics, the example photonic biosensor disclosed herein provides a dry solution that removes many of the on-analyzer process steps. Many on-analyzer steps are instead designed into the biosensor itself, such as sample-reagent mixing and sample analysis. The example photonic biosensor disclosed herein also reduces labor and operation expense, which provides for instrumentation that is significantly reduced in size and complexity while providing relatively high throughput.

The ability to measure immunoassays utilizing label free photonics significantly reduces the amount of required reagent (100's of picoliters vs 100's of microliters for traditional immunoassays). Further, the disclosed photonic biosensors reduce complexity of reaction processes (reduced instrument hardware) and provide a reduction in turnaround/analysis time (5-10 minutes). Further, as disclosed herein, the example biosensors provide for multiplexing of strategic test panels.

### Photonic Biosensor Embodiment

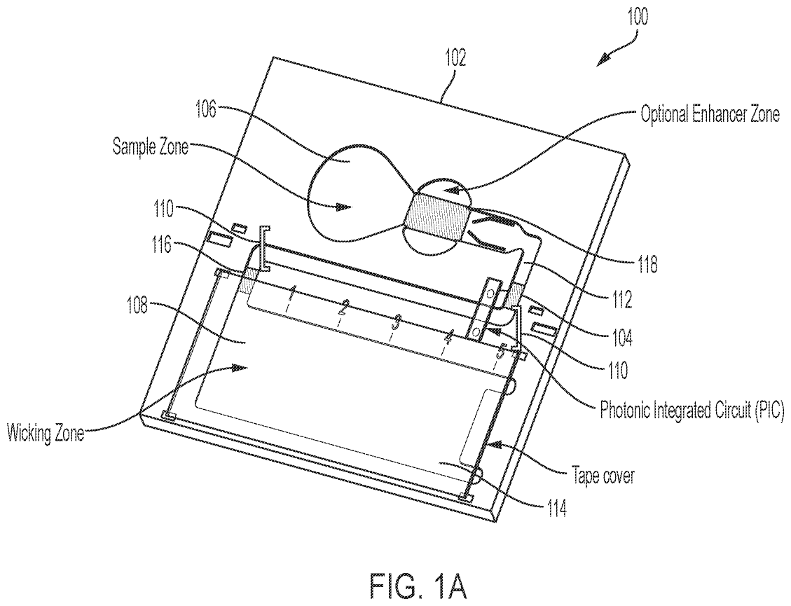

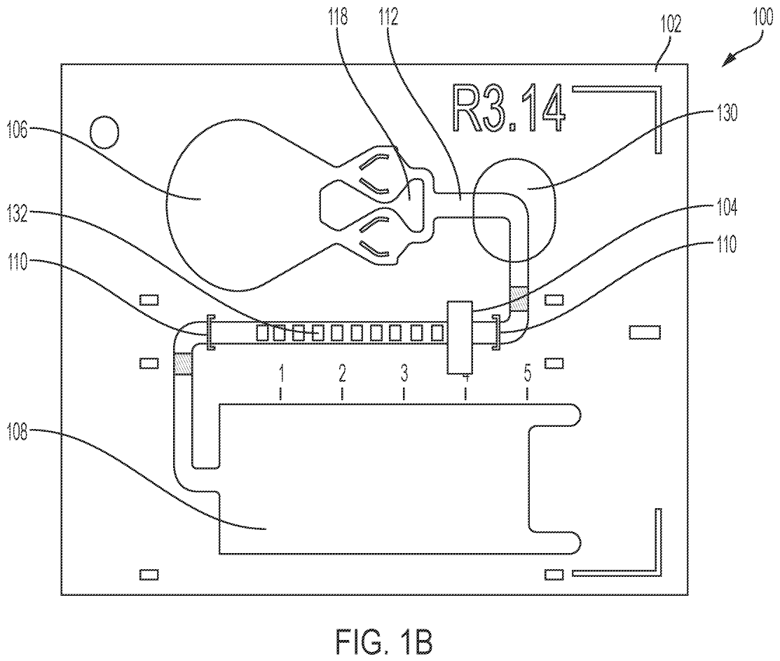

FIG. 1A is a diagram of a photonic biosensor 100, according to an example embodiment of the present disclosure. The example biosensor 100 includes a substrate 102, which may include a test card, a slide, or a cassette. The substrate 102 may be constructed from glass, plastic, composites, cyclic olefin copolymers, polystyrene, polymethymethacrylate (“PMMA”), nylon, polycarbonate, or combinations thereof. Further, the substrate 102 may be manufactured via hot embossing, micro molding, or any other molding or printing method.

The example substrate includes a sample addition zone 106, a wicking zone 108, and a detection zone 110. The zones 106 to 110 are fluidly coupled together (e.g., in fluid communication) via a fluid pathway 112. The sample addition zone 106 includes a metering port for receiving a fluid sample. The example wicking zone 108 provides an area for flow control and/or waste collection. The wicking zone 108 provides a termination point of the fluid pathway 112, while the sample addition zone 106 provides a starting point. In some embodiments, the wicking zone 108 may be covered by tape support 114, which provides physical protection of accumulated fluid sample in the wicking zone 108. An entry section 116 leading to the wicking zone 108 may be configured to pull the fluid sample into the wicking zone 108 to prevent the fluid sample from backing up through the detection zone 110.

The example substrate 102 may, in some embodiments, include an optical enhancer zone 118 (e.g., a conjugate zone). The optical enhancer zone 118 is located downstream from the sample addition zone 106. In some embodiments, the optical enhancer zone 118 is located adjacent to the sample addition zone 106. Further, the optical enhancer zone 118 is located upstream from the detection zone 110 and the wicking zone 108. The optical enhancer zone 118 includes one or more reagents for binding with a fluid sample. In some embodiments, the fluid sample dissolves fluorescent labeled conjugates as the fluid sample flows through the optical enhancer zone 118.

The example detection zone 110 includes one or more test zones that are configured to capture a bound specific antigen/conjugate complex. The different test zones may provide for the detection of a sample analyte or different analytes. A concentration or presence of bound antigen/conjugate complex at each test zone is measured using fluorescence or colorimetric detection. In some instances, after conjugate in the optical enhancer zone 118 is completely dissolved, the fluid sample acts as a wash and removes unbound material into the wicking zone 108. After a complete wash by the fluid sample, the test zones of the detection zone 110 may be read with a fluorimeter or other optical analyzer. It should be appreciated that in some embodiments, the detection zone 110 may not be needed. In these embodiments, the detection zone 110 is replaced by the fluid flow path 112.

In some embodiments, at least some of the fluid pathway 112, the sample addition zone 106, the optical enhancer zone 118, the detection zone 110, and/or the wicking zone 108 may include a plurality of projections or micropillars. The example projections or micropillars are substantially vertical to a surface of the substrate 102 and have a height, diameter, and reciprocal spacing such that lateral capillary flow of the fluid sample is achieved. In some embodiments, the projections or micropillars have a height that is between 1-1000 micrometers (“μm”), a diameter that is between 10-100 μm, and reciprocal spacing that is between 5-100 μm, preferably between 10-25 μm. In some instances, a base of the projections or micropillars may have a greater diameter compared to a top. In these instances, a diameter of the projections or micropillars may taper from the base to the top.

The example substrate 102 shown in FIG. 1A is described further in U.S. Pat. Nos. 10,073,091, 9,689,870, 9,389,228, 9,285,361, 8,895,293, 8,821,812, 8,409,523, and 8,025,854, where are hereby incorporated by reference and relied upon.

FIG. 1B is a diagram of another photonic biosensor 100, according to an example embodiment of the present disclosure. The photonic biosensor 100 includes a substrate 102 similar to the substrate 102 of FIG. 1A. The photonic biosensor 100 also includes a sample addition zone 106, a wicking zone 108, a detection zone 110, a fluid pathway 112, and an optical enhancer zone 118. The photonic biosensor 100 further includes a wash zone 130 that is located between the optical enhancer zone 118 and the detection zone 110 along the fluid pathway 112. The wash zone 130 is configured to receive a reagent and/or surfactant to provide an auxiliary wash to improve removal of unbound material. In some embodiments, a fluid may be added to the wash zone 130 to flow upstream and downstream to pre-wet the fluid pathway 112 prior to a sample being added to the sample addition zone 106. The wash zone 130 may also provide for a sample wash.

The illustrated example, FIG. 1B shows that the PIC 104 may be used in conjunction with one or more detector sections 132 of the detection zone 110. The detector sections 132 may be configured for colorimetric/digital detection and/or fluorescence detection. The sample addition zone 106 is configured to receive serum/plasma, whole blood, or other fluids for analysis by the PIC 104 and the detector sections 132. The optical enhancer zone 118 may provide one or more capture options, including conjugate capture and/or mass enhancer capture. Further, the wicking zone 108 may include one or more features such as fluid control and/or end of test detection. In some embodiments, the wicking zone 108 may include a porous material to enhance fluid flow. Further, in some embodiments, the PIC 104 may be located upstream from or otherwise adjacent to the detection zone 110.

As described above in connection with FIG. 1A, the fluid pathway 112 may provide for fluid flow using micropillars. The micropillars may be placed in the sample addition zone 106, the wicking zone 108, the detection zone 110, optical enhancer zone 118, the wash zone 130, and/or space between these zones along the fluid pathway 112. In other embodiments, capillary flow may be achieved without the use of micropillars. For example, capillary flow along the fluid pathway 112 and/or the zones 106, 108, 110, 118, and/or 130 may be achieved using texturing/surface patterning. Alternatively, capillary flow may be achieved using porous media (e.g., “paper in poly”, fiber materials, or thread/fabric bundles). In other embodiments, capillary flow may be provided using a thin film coating and/or various coated spreading layers and channel beads. Coatings to provide a wettable/hydrophilic surface for the fluid pathway 112 and/or the zones 106, 108, 110, 118, and/or 130 include oxygen plasma treatment, neutral atom beam bombardment, gas cluster ion beam bombardment, surface silanization, etc.

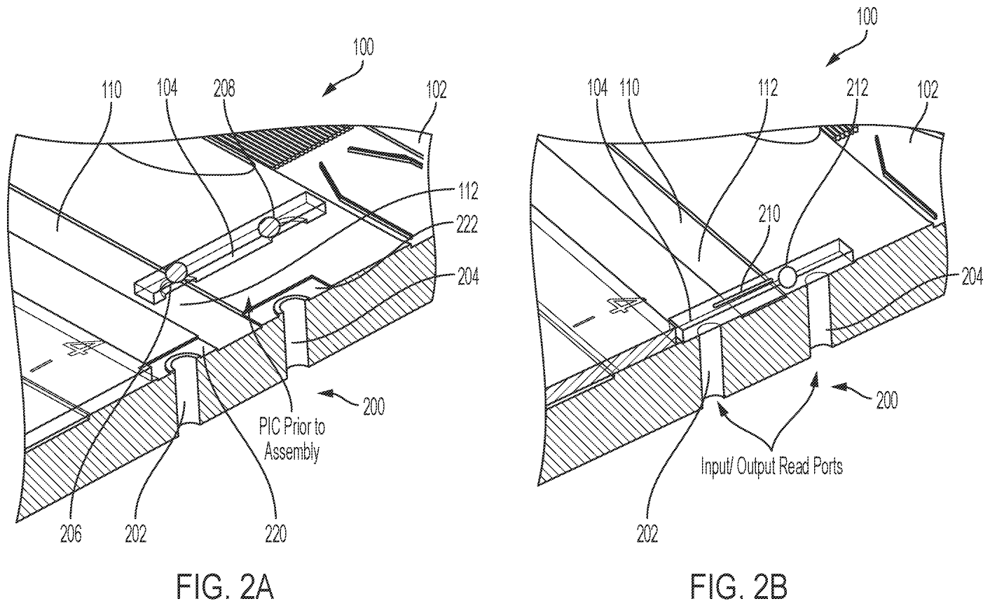

The example substrate 102 of FIGS. 1A and 1B also includes optical ports for non-contact optical coupling with a read head of a laboratory analyzer or PoC analyzer. FIGS. 2A and 2B show a cut-away of the substrate 102 at a section 200 of the sample detection zone 110 that includes an optical input port 202 and an optical output port 204, according to an example embodiment of the present disclosure. The input port 202 is configured to optically couple to a light source and the output port 204 is configured to optically couple to a light detector. To provide non-contact optical alignment, the substrate 102 is positioned in an analyzer instrument such that a light source is directly aligned with the optical input port 202. Similarly, the positioning of the substrate 102 in the analyzer instrument causes the output port 204 to align with an optical detector. This non-contact coupling eliminates the need for complex optical coupling with the PIC 104.

The optical input port 202 includes a first tunnel through the substrate 102 and the optical output port 202 includes a separate, second tunnel through the substrate 102. While the tunnels are shown as being cylindrical, the tunnels may have other profiles, such as rectangular triangular, etc. In the illustrated embodiment, the input port 202 is shown as being on one side of the fluid pathway 112, while the output port 204 is shown as being on an opposite side of the fluid pathway 112. In other embodiments, the ports 202 and 204 maybe on a same side of the fluid pathway 112.

FIGS. 2A and 2B also show an enlarged view of the PIC 104. FIG. 2A shows a diagram of the PIC 104 prior to connection to the substrate 102. FIG. 2B shows a diagram of the PIC 104 after placement on the substrate 102. As shown in FIGS. 2A and 2B, the example PIC 104 includes a first grating coupler 206 that is aligned with the optical input port 202. The PIC 104 also includes a second grating coupler 208 that is aligned with the optical output port 204. The grating couplers 206 and 208 have shapes that conform to the circular profiles of the respective optical ports 202 and 204.

The grating couplers 206 and 208 include periodic etch structures that diffract light in a certain direction. In the illustrated example, the grating coupler 206 diffracts light from a vertical direction through the optical input port 202 to a horizontal direction through the PIC 104. Additionally, the grating coupler 208 diffracts light from a horizontal direction from the PIC 104 to a vertical direction through the optical output port 204. In other embodiments, the grating couplers may be replaced with mirrors or a reflective coating that directs light between the ports 202 and 204 and the PIC 104.

The example PIC 104 also includes at least one waveguide 210 between the first grating coupler 206 and the second grating coupler 208. Further, the PIC 104 includes at least one detection element 212 that provided along the at least one waveguide 210. The detection element 212 is positioned to contact a fluid sample within the fluid pathway 112. It should be appreciated that the detection element 212 and/or the PIC 104 generally does not block fluid passage along the fluid pathway 112. Instead, a small space is provided between a floor of the fluid pathway 112 and the detection element 212 to enable a fluid sample to pass through. In some embodiments, the small space is between 10 μm and 5000 μm.

Also, as shown in FIG. 2A, the substrate 102 may include recess sections 220 and 222 around the ports 202 and 204 for receiving corresponding sides of the PIC 104. The recessed sections 220 and 222 enable the PIC 104 to be securely connected to the substrate 102. In some embodiments, at least one of an ultraviolet (“UV”) curable adhesive, physical stacking, or a tape/glue application is used to secure the PIC 104 to the substrate 102 at the recess sections 220 and 222.

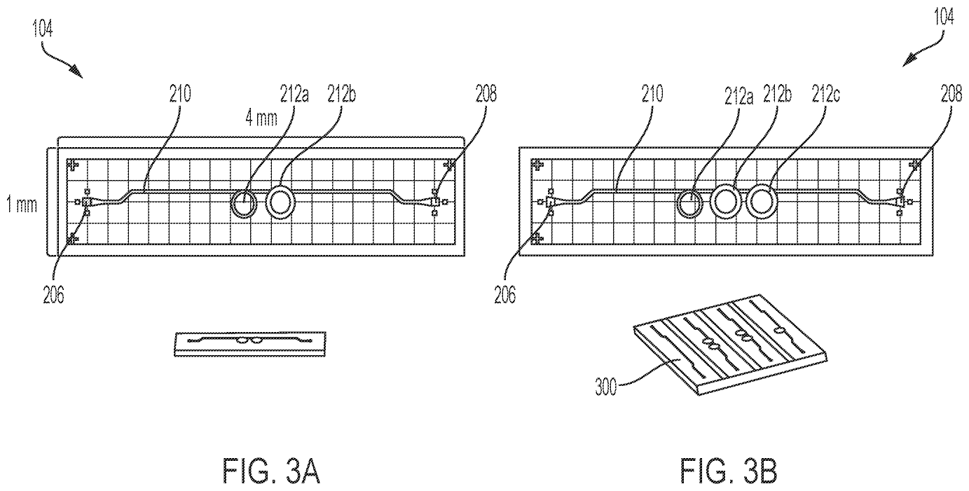

FIGS. 3A and 3B are diagrams of example PICs 104, according to example embodiments of the present disclosure. FIG. 3A shows a PIC 104 with two detection elements 212a and 212b, which are located along a waveguide 210. The example waveguide 210 is optically coupled to a first grating coupler 206 and a second grating coupler 208. The detection elements 212a and 212b include ring resonators. In other embodiments, the detection elements 212a and 212b may include double ring resonators, cylindrical resonators, spherical resonators, spiral waveguides, or Mach-Zehnder Interferometers (“MZI”). Further, the waveguide 210 may include a silicon nitride waveguide.

As shown, the PIC 104 of FIG. 3A has a rectangular prism or cuboid shape. Further, the PIC 104 has a length between 2-20 mm (e.g., 4 mm), a width between 0.25-10 mm (e.g., 1 mm), and a height between 0.25-5 mm. FIG. 3B shows that an array of PICs 104 may be connected to the substrate 102 for multiplex applications. As shown, one, two, or three detection elements 212a, 212b, and 212c may be included. Further, as shown in FIG. 3B, a PIC 300 with zero detection elements may be included in an array. The PIC 300 may be used as a reference for light calibration and/or adjustment. The four PICs of FIG. 3B may each be placed across the fluid pathway 112 to contact a sample fluid. The substrate 102 may include one optical input port 202 and one optical output port 204 for all four of the PICs 104. Alternatively, the substrate 102 may include separate optical input ports 202 and separate optical output ports 204 for each of the four PICs 104.

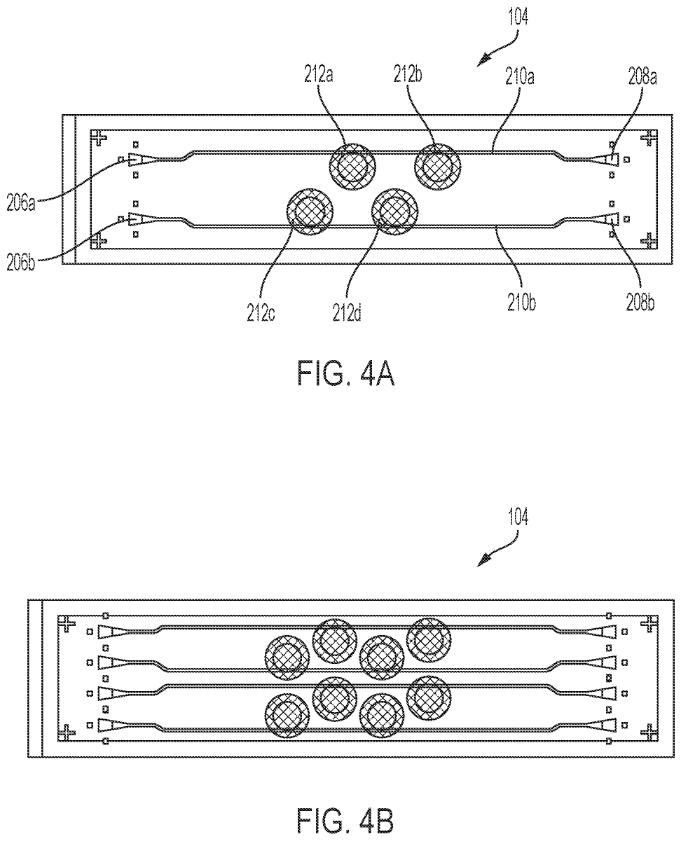

FIGS. 4A and 4B show diagrams of alternative embodiments of the PIC 104, according to example embodiments of the present disclosure. The PIC 104 of FIG. 4A includes two parallel waveguides 210a and 210b. Each waveguide 210 is optically coupled to a respective input port 202 and output port 204 of the substrate 102 via grating couplers 206a, 206b, 208a, and 208b. Further each waveguide 210a and 210b includes respective detection elements 212a, 212b, 212c, and 212d. FIG. 4B shows an embodiment in which the PIC 104 includes four parallel waveguides, each having its own input/output ports and detection elements. It should be appreciated that there is virtually no limit on the arrangement and configuration of waveguides and detection elements on a PIC.

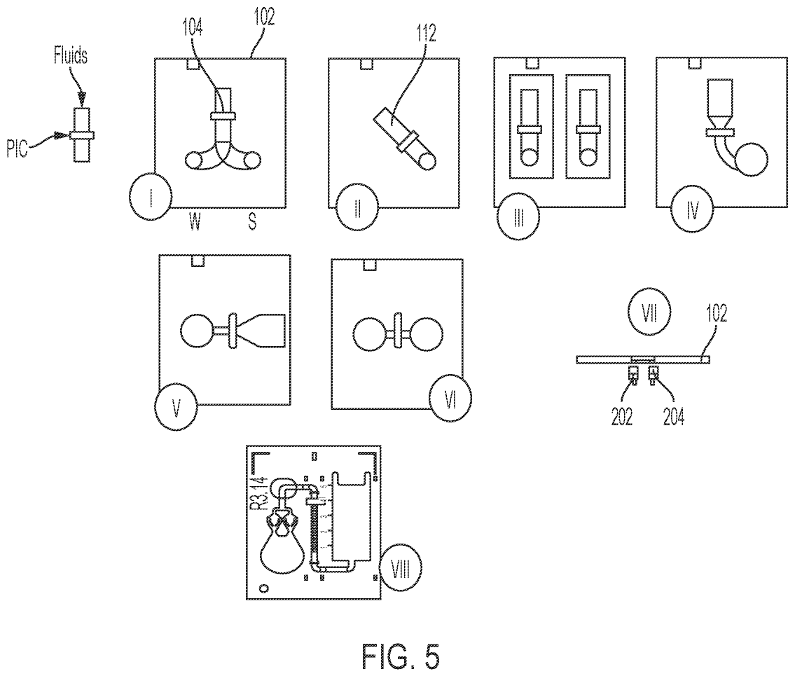

FIG. 5 is a diagram of alternative embodiments of the substrate 102 and the PIC 104, according to example embodiments of the present disclosure. As shown in the different embodiments, the PIC 104 may be placed across any fluid pathway configuration of the substrate 102. This includes configurations where two different samples (or a sample and a reagent) are added separately in separate pathways (example I). This also includes a PIC 104 provided on a diagonal fluid pathway (example II). This further includes separate PICs 104 for respective fluid pathways (example III). As shown, there is virtually no limit to the number of different arrangement of fluid pathways on a substrate for which the example PIC 104 disclosed herein may be used, as shown in examples IV to VIII. Further, example VII shows that the input port 202 and output port 204 may extend from the substrate 102 for optically coupling with a light source and detector.

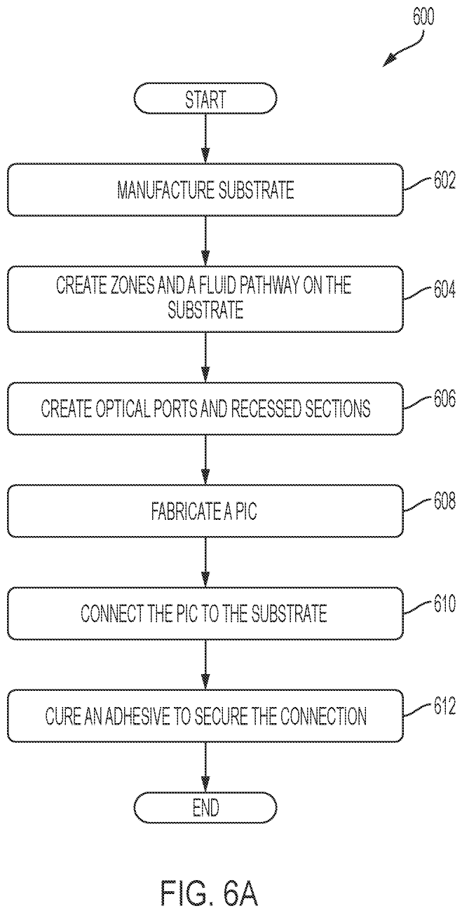

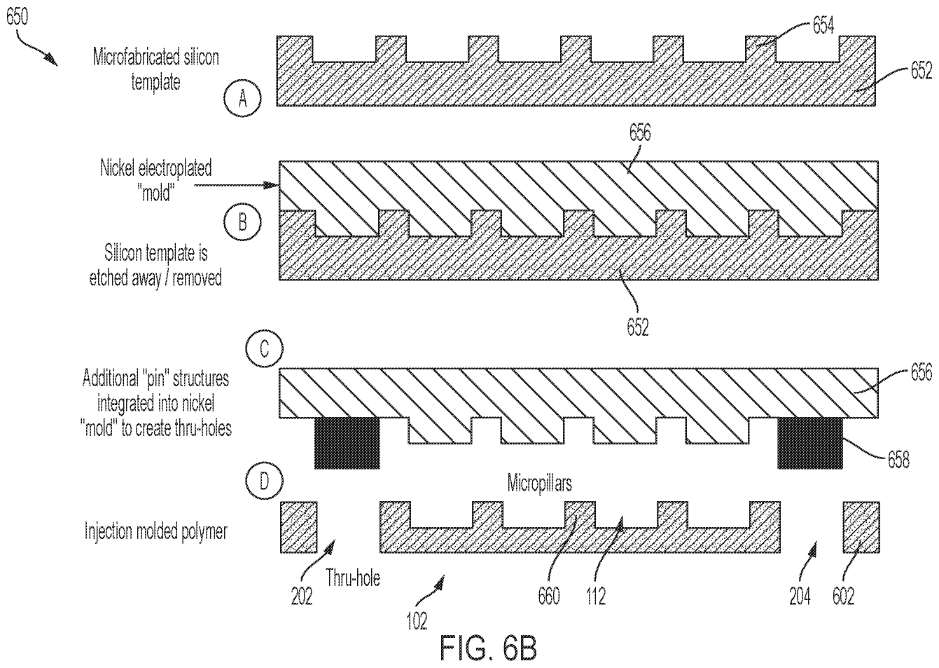

FIG. 6A is a diagram of a procedure 600 for manufacturing the photonic biosensor 100 of FIG. 1A or 1B, according to an example embodiment of the present disclosure. Although the procedure 600 is described with reference to the flow diagram illustrated in FIG. 6A, it should be appreciated that many other methods of performing the steps associated with the procedure 600 may be used. For example, the order of many of the blocks may be changed, certain blocks may be combined with other blocks, and many of the blocks described may be optional. In an embodiment, the number of blocks may be changed based on the number and/or types of PICs to be placed on a substrate.

The example procedure 600 begins when a substrate 102 is manufactured (block 602). The substrate 102 may be manufactured via hot embossing, micro molding, injection molding, or any other molding or printing method. Next, zones and a fluid pathway are created on the substrate (block 604). The zones may include a sample addition zone, an optical enhancer zone, a wicking zone, a detection zone, a wash zone, etc. Test zones may be included within the detection zone. Further, a reagent or conjugate may be added to the optical enhancer zone. In some embodiments, the recess sections defining the zones and fluid pathway are formed when the substrate 102 is formed. In other instances, the recessed sections are etched. A layer is then added, including micropillars or protrusions to provide for capillary flow through the zones and fluid pathway. Further, a cover may be placed on the wicking zone.

The example procedure 600 continues by boring or otherwise forming optical ports and recessed sections for connection to a PIC (block 606). In some instances, the ports and recessed sections are formed when the substrate 102 is formed via, for example, injection molding. Alternatively, the ports may be bored using a drill or other similar structure. Further, in some instances, the walls of the formed tunnels of the ports may be coated with a reflective or non-reflective coating.

FIG. 6B is a diagram illustrative of an example process 650 to form the substrate 102 using injection molding, according to an example embodiment of the present disclosure. In a first step (Step A) of the process 650, a silicon template 652 is formed. The silicon template 652 maybe formed using silicon-based micromachining techniques to grow/etch the desired structure. The template 652 defines dimensions for template micropillars 654, which may otherwise be difficult to form.

The process 650 continues at Step B where nickel, copper, gold, or another metal is electroplated to form a mold 656. In some instances, the mold 656 may be formed via metal sputtering. The silicon template 652 is next removed or otherwise etched to leave the mold 656.

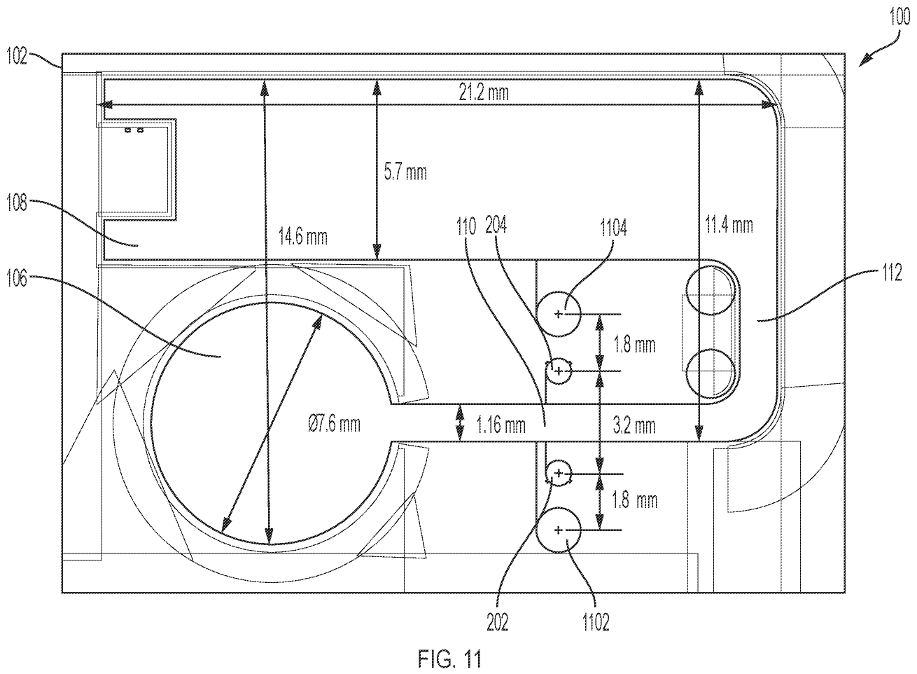

In a next step (Step C) of the process 650, one or more pin structures 658 are integrated or otherwise connected to the mold 656. The pin structures 658 are placed for forming the ports 202 and 204 of the substrate 102. The pin structures 658 may also be placed for forming alignment through holes, discussed below in connection with FIG. 11.

The example process 650 continues at Step D where a polymer is injection molded into the mold 656. After curing, the injection molded polymer is removed from the mold 656 to form the substrate 102. As shown, micropillars 660 in the fluid flow path 112 are formed in spaces of recessed sections of the mold 656. Such a configuration enables micropillars 660 to be formed at the micrometer scale. Further, the pin structures 658 form the ports 202 and 204 in the substrate 102, thereby eliminating the need to drill into the substrate to form the ports.

Returning to FIG. 6A, in conjunction with the substrate 102 being created, a PIC 104 is fabricated (block 608). The PIC 104 is fabricated using silicon-based microscale or nanoscale manufacturing processes and is functionalized prior to mounting. The PIC 104 may then be separated from a fabrication die and mounted on the substrate 102 (block 610). An adhesive used to mount the PIC 104 is then cured to create a secure connection (block 612). Attachment of the PIC 104 can be achieved by a UV curable adhesive, physical stacking, and/or a tape application to the microfluidics substrate 102. The example procedure 600 then ends and the photonic biosensor 100 may be used to detect one or more analytes in a fluid sample.

It should be appreciated that the separation of the core photonic PIC from pure microfluidics enables optimization (and improves cost efficiency) of each manufacturing process. The completed photonic biosensor 100 is a dry slide, which uses microfluidics of the substrate 102 for sample transport and the functionalized PICs 104 for single or multiplexed testing and assay concentration. The assay results provided by the PIC are measured using a tunable laser and/or solid state photodetectors. In some instances, a broad-spectrum source and/or a spectrum analyzer may be used to determine the change in resonance wavelength at the PICs.

### Testing Embodiment

As described above, the photonic biosensor 100 with the PIC and substrate 102 is configured to test for one or more analytes. The test process using the photonic biosensor 100 includes dispensing a fluid sample onto a sample addition zone, incubating the sample, and performing a read operation. Many additional features may be utilized to enhance performance such as a pre-wash to remove stability coatings. An additional post wash may be used to remove unbound material after sample completion.

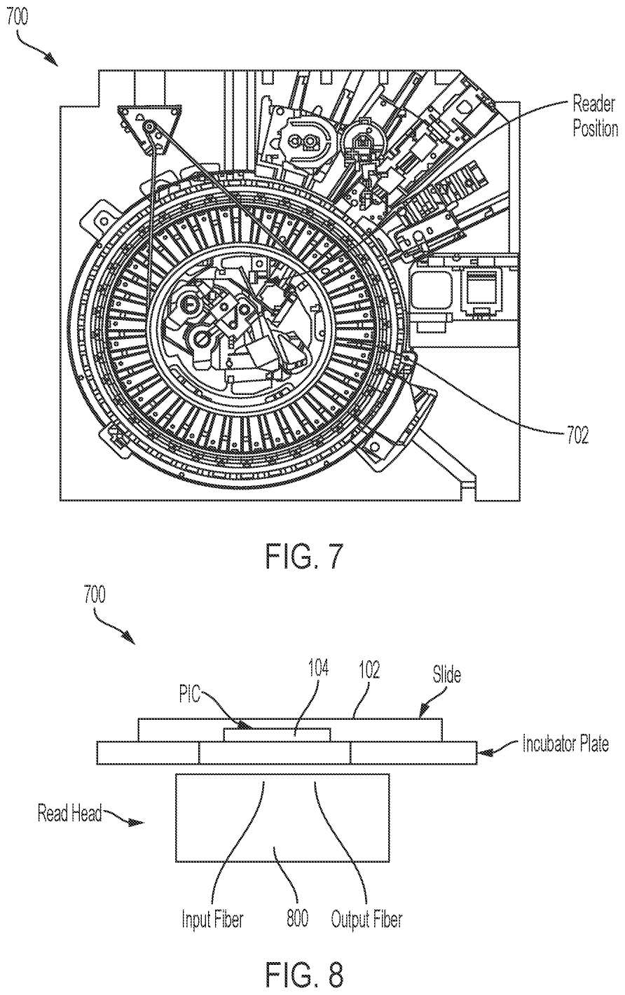

The example photonic biosensor 100 disclosed herein is compatible with dry slide processing. Common instrument functions can be utilized for both dry chemistry and the photonic biosensor 100. FIGS. 7 to 9B show diagrams of laboratory instrumentation 700 that may be used in conjunction with the photonic biosensor 100 of FIG. 1A or 1B, according to an example embodiment of the present disclosure. FIG. 7 shows that the photonic biosensor 100 may be placed in a circular track 702 with other photonic biosensors 100. The circular track 702 (or rack) is configured to receive new photonic biosensors 100 from a supply stock and rotate the new photonic biosensors 100 to receive a wash buffer and/or patient fluidic sample from one or more pipettes. The circular track 702 may provide for incubation of patient samples on the photonic biosensors 100 and enable the photonic biosensors 100 to be moved to a read position after incubation. After reading, the circular track 702 provides routing for discarding the used photonic biosensors 100.

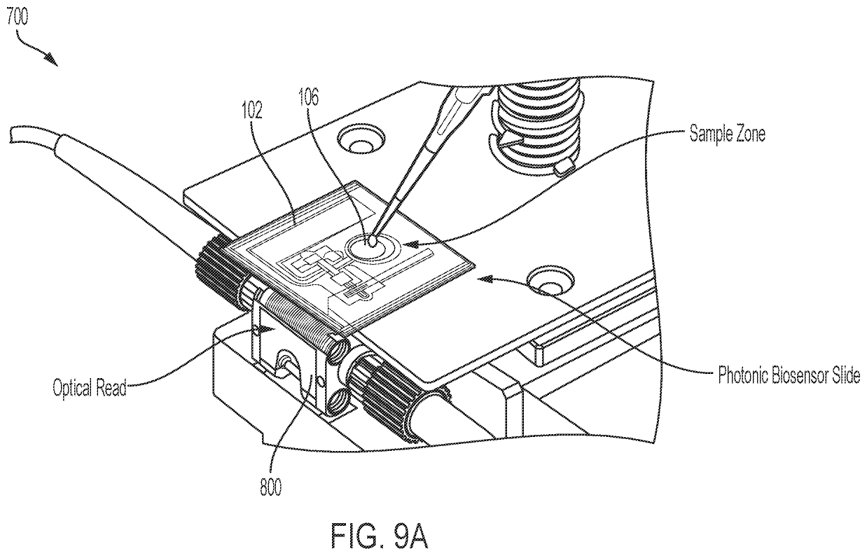

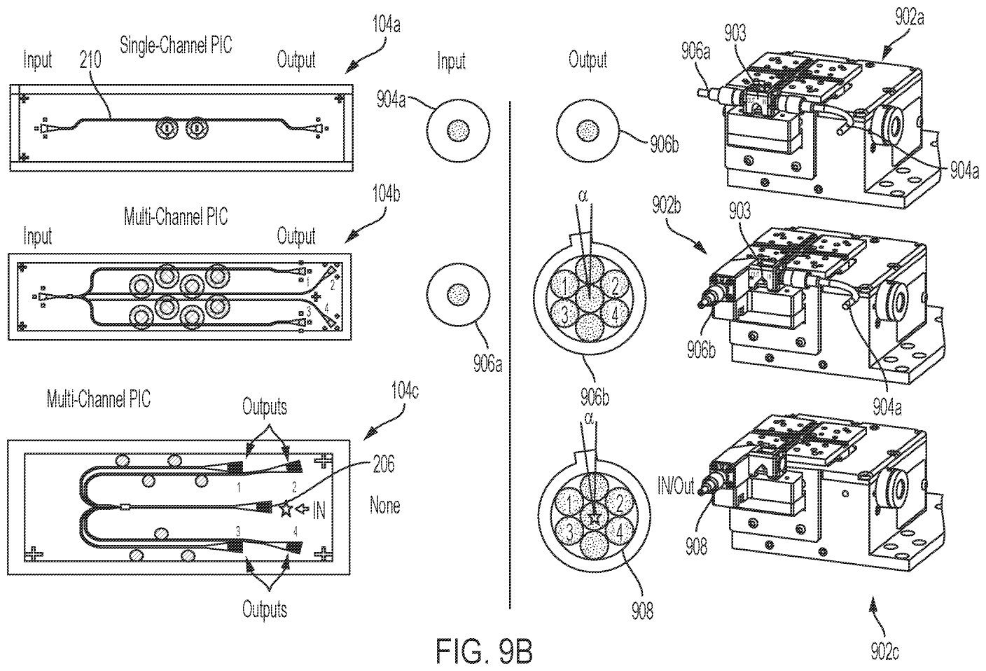

As shown in FIGS. 8 and 9A, a fluid sample is applied to the substrate 102, and incubated. Once incubation is complete, the biosensor 100 is moved from the incubator and into a photonic reader 800. The reader 800 may include an input fiber connected to a light source and an output fiber connected to a light detector. The input fiber is aligned with the optical input port 202 of the substrate 102 while the output fiber is aligned with the optical output port 204 of the substrate. Once placed in a read location, the PIC 104 is precisely positioned and scanned. Once completed, the biosensor 100 is transferred to waste.

FIG. 9B is a diagram that shows possible optical configurations, according to an example embodiment of the present disclosure. In a first embodiment, a fixture 902a includes an optical hub 903 having an input connector 904a and an output connector 906a. Each of the connectors 904a and 906a include a single optical fiber for optical coupling with the PIC 104a, which has a single waveguide 210. As discussed above in connection with FIGS. 2A and 2B, the input connector 904a is optically coupled to the input port 202 of the substrate 102 and the output connector 906a is optically coupled to the output port 204 of the substrate 102.

In a second embodiment, a fixture 902b includes the optical hub 903 with the input connector 904a. The optical hub 903 also includes an output connector 906b that has at least four optical fibers. In some instances, the output connector 906b includes seven optical fibers, but only four of the fibers are used. In this second embodiment, the PIC 104b has four waveguides that branch from the grating coupler 206. Each waveguide includes two detection elements. Further, each of the four waveguides terminates at a separate grading coupler (numbered 1 to 4), which is optically coupled respectively to the four optical fibers of the output connector 906b via the output port 204 of the substrate 102 (also numbered 1 to 4). This configuration enables light from each of the four waveguides to be independently received in the fixture 902b for separate analysis. In an example, the use of the four waveguides provides for multiplexed analysis of a fluid sample.

In a third embodiment, a fixture 902c includes a combined input/output connector 908 that has four output optical fibers and a single input optical fiber. In this embodiment, the input optical fiber is located in a center of the connector 908 for providing light to the detection elements on the PIC 104c. In other embodiments, the input optical fiber may be located at any one of the seven optical fibers based on the grading coupler 206/208 locations of the PIC 104c.

The PIC 104c includes a grading coupler 206 that is aligned with the input optical fiber of the connector 908. The grading coupler 206 is optically connected to a single waveguide that branches into four waveguides having U-shapes. Output grading couplers (numbered 1 to 4) are aligned with corresponding output optical fibers (also numbered 1 to 4). The use of the U-shape waveguides enables light to exit the PIC 104c at the same side at which light is received. This configuration of the PIC 104c enables the single combined input/output connector 908 to be used. The substrate 102 may include a single port 202 or 204 for optical coupling with the combined connector 908. This third embodiment is more efficient than the first and second embodiments since only one port 202/204 is formed in the substrate 102 and only one optical coupling is needed via the connector 908 during testing of a patient fluid sample.

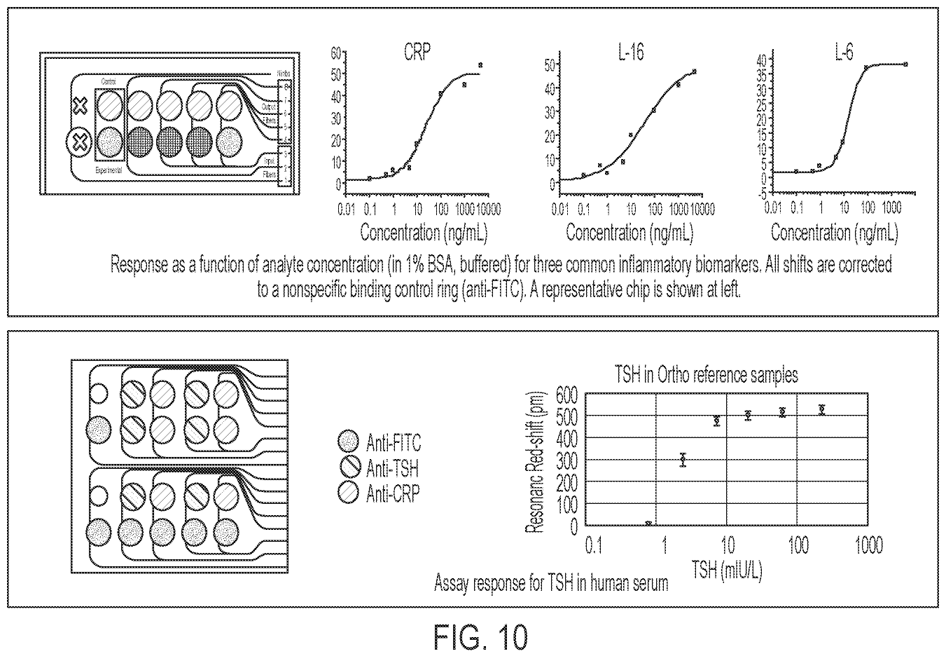

FIG. 10 is a diagram of example response curves of the PIC 104 of the photonic biosensor 100 of FIG. 1, according to an example embodiment of the present disclosure. The response curves show that the PIC 104 accurately detects a concentration of certain biomarkers. The example biosensor 100 is compatible with mainframe laboratory analyzers and POC devices. The disclosed biosensor 100 is ideally suited for multiplex test panels.

It should be noted that a combination of detection methods may be provided on a single substrate 102 having a PIC 104. For example, photonic detection provided by the PIC 104 may be combined with fluorescence and colorimetric detection in a detection zone of the substrate, thereby providing a full range of test capabilities in a single biosensor. In some embodiments, the photonic results may be validated or interpreted with reference to results from fluorescence and colorimetric detection. Inconsistent results may be interpreted as an inconclusive test, and may require further analysis using additional biosensors 100.

### Alignment Embodiment

As discussed above in connection with FIGS. 7 to 9, the laboratory instrumentation 700 includes a photonic reader 800 that optically couples to the biosensor 100. FIG. 11 is a diagram of an embodiment showing features of the biosensor 100 that enable the photonic reader 800 to relatively quickly optically couple with the PIC 104, according to an example embodiment of the present disclosure. In the illustrated example, alignment channels 1102 and 1104 are formed in the substrate 102. The alignment channels 1102 and 1104 may include through holes or apertures, and are located adjacent to respective ports 202 and 204.

In an example, the photonic reader 800 includes alignment pins. After the biosensor 100 is moved into a specified location within the laboratory instrumentation 700, the photonic reader 800 and/or the substrate 102 is moved such that the alignment pins pass through the alignment channels 1102 and 1104. This provides a relatively fast alignment. In some embodiments after the rough alignment, the photonic reader 800 and/or the substrate 102 may have alignment fine-tuned to ensure a light source and a light detector are optically aligned respectively with the optical input port 202 and the optical output port 204.

It should be noted that while FIGS. 1A, 1B, 2A, 2B, and 11 show one input port 202 and one output port 204, in other embodiments, the substrate 102 may have more than one input port and/or more than one output port. The use of multiple ports enables, in some embodiments, the use of multiple channels in the PIC 104 for multiplexing. For example, the substrate 102 may have a single input port 202 and multiple output ports 204. In this example, the PIC 104 has multiple channels corresponding to the number of output ports 204. Light received via the input port 202 is split along the separate channels to provide different types of optical analysis. Additionally or alternatively, the substrate 102 may include multiple input ports 202 and multiple output ports 204 (and/or multiple pairs of alignment channels) to accommodate multiple PICs 104 placed at different locations along the flow path 112.

FIG. 11 also shows approximate dimensions of the biosensor 100, which has a length of about 22 mm and a width of about 15 mm. In this example, the sample addition zone 106 has a width of 5.7 mm and a length of 21.2 mm. The flow path has a width of 1.16 mm, and the wicking zone 108 has a diameter of 7.6 mm. It should be appreciated that the biosensor 100 may have alternative dimensions based on design and end-use application.

In some embodiments, the alignment channels 1102 and 1104 and the ports 202 and 204 may be omitted. In these alternative embodiments, light coupling is provided directly to the waveguide 210 of the PIC 104. In an example, an input fiber connected to a light source is configured to align with a side of the PIC 104 to optically couple directly with the waveguide 210. An output fiber is placed on an opposing side of the PIC 104 to receive the light.

### Micropillar Embodiment

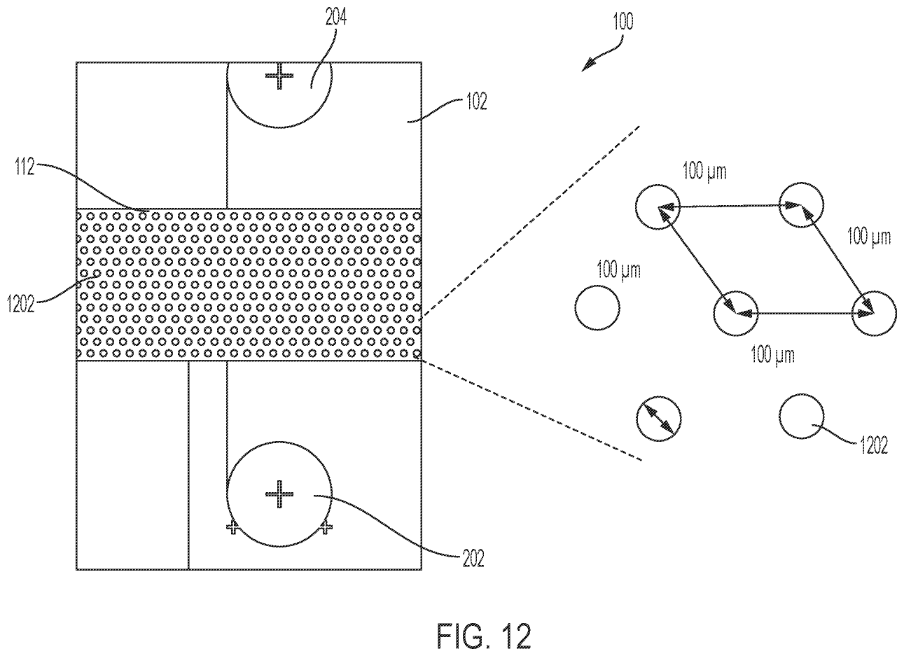

FIG. 12 is a diagram of an example micropillar layout for a fluid flow path 112 of the substrate 102 for the biosensor 100 of FIGS. 1A and 1B, according to an example embodiment of the present disclosure. Micropillars 1202 (e.g., the micropillars 660 of FIG. 6B) are placed within the fluid flow path 112, including at locations along the fluid flow path 112 that align with a functionalized detection element 212 of the PIC 104. The micropillars 1202 may include cylinders having 50 μm diameters. As shown, the micropillars 1202 are placed in a hexagonal array such that the micropillars 1202 are spaced apart by 100 μm. The spacing and size of the micropillars 1202 provides for capillary flow along the fluid flow path 112.

In other embodiments, the micropillars 1202 have a rectangular shape. In these other embodiments, the micropillars may be placed into rows, with 50 μm to 150 μm of space between adjacent micropillars. Further each adjacent row may be offset from other rows. The offset may correspond to gaps of adjacent rows such that a micropillar in one row is aligned with a gap between micropillars in an adjacent row.

### Measurement of SARS-CoV-2 Antibodies Embodiment

The example biosensor 100 discussed above may be used in many different applications for identifying biological and/or chemical analytes. In one example, the biosensor 100 is configured to measure and/or detect SARS-CoV-2 antibodies. In this example, PICS 104 were prepared by removing them from a wafer and washing for 30 minutes in a 1:1 mixture of methanol and hydrochloric acid. The PICS 104 were then rinsed three times for 30 seconds each time in Nanopure water and dried with nitrogen. The PICS 104 were submerged in 1% (3-triethoxysilyl) propylsuccinic anhydride (Gelest®, Morrisville, PA) in anhydrous toluene for 40 minutes, and then rinsed in pure anhydrous toluene for 5 minutes. The PICS 104 were next dried with nitrogen and incubated at 110° C. for 30 minutes.

After a surface of detection elements 212 (e.g., ring resonators) are functionalized, antibodies were covalently attached to the surface by spotting them directly on the detection elements 212 using a sciFLEXARRAYER SX piezoelectric microarrayer (Scienion AG, Berlin, Germany). A control ring resonator was spotted with anti-fluorescein antibody at 65011 g/mL, and a test ring resonator was spotted with SARS-CoV-2 receptor-binding domain (“RBD”) peptide (Sino Biologicals, Wayne, PA) at 400 μL/mL. Both rings received approximately 3 nL of antibody/antigen solution. The PICS 104 were maintained at 75% humidity for 30 minutes, then an equivalent volume of stabilizer solution (StabilCoat Immunoassay Stabilizer, Surmodics IVD Inc., Eden Prairie, MN) was applied. 30 minutes after the stabilizer was spotted onto the rings of the detection elements 212, the PICs 104 were removed from the arrayer and kept in a vacuum desiccator until use.

The substrate 102 (e.g., a fluidic card) of the biosensor 100 was formed and first treated with oxygen plasma for one minute to increase the hydrophilicity of the fluid flow path 112 (Plasmod Plasma System, Nordson Plasma Systems, Concord, CA). Double-sided, 57-μm-thick adhesive tape (467MP, 3M®, St. Paul, MN) was patterned to interface the substrate 102 with the PIC 104. The adhesive covered the entirety of the micropillar channels of the fluid flow path 112, leaving small windows for the photonic gratings to be accessed with optical fiber signals, and for ring resonator sensors to access a flow of sample through the channel. Additionally, a large inlet hole enabled access with a pipette for sample addition to the sample addition zone 106. Patterned adhesive tape was added to the substrates 102 using a custom alignment device, and a strip of filter paper (Q1, Whatman®, Little Chalfont, UK) was placed between the micropillar outlet channel and adhesive, to facilitate continuous flow once the channel of the fluid flow path 112 had filled. Once the adhesive was applied to the substrate 102, PICs 104 were aligned to the channel and optical-access ports 202 and 204.

The biosensor 100 was aligned to an optical source, which consisted of a custom vertical coupling component (Syntec Optics®, Rochester, NY) that allowed for light to be coupled to and from the photonic grating couplers from below the substrate 102. The biosensor 100 was placed on a micrometer-controlled stage, and alignment was performed using an infrared camera and power meter until the power coupled through the stage was at a maximum. Polarization controllers were used to further improve coupling, and the spectral range was selected to minimize background signal, generally around 1552-1558 nanometers (“nm”).

After the biosensor 100 was aligned, 6-nm spectra recordings were obtained continuously, generally around 1550 nm, with each spectral measurement taking about 6 seconds. All spectra were automatically saved for analysis. Once a spectrum was acquired after alignment, samples were sequentially added at varying volumes. First, 20 μL of pooled normal human serum (“PNHS”—Innovative Research®, Novi, MI), diluted 1:5 in assay wash buffer (“AWB”), was added. This step served three purposes: first, to wash off the stabilizer and expose the antigen-functionalized rings, second, to enable the peak from each ring resonator of the detection element 212 to equilibrate to an environment with a similar bulk refractive index to that of the patient samples, and third, to block nonspecific binding sites. Once the bolus of sample over the inlet had diminished, but not dried out, the serum sample to be measured was added. As with the PNHS, the sample was diluted 1:5 in AWB. Next, 5 μL of AWB was added to wash away any unbound material and match the bulk refractive index of the next sample. Lastly, 10 μL of goat anti-hIgG antibody (Jackson Immunoresearch®, West Grove, PA) at 10 μg/mL was added to confirm that the shift seen from the addition of sample was due to anti-RBD antibodies binding to the ring resonator of the detection element 212.

The results of the analysis of the SARS-CoV-2 antibodies with the biosensor 100 were analyzed to determine validity and accuracy. The data showed for monoclonal antibodies raised against SARS-CoV-2 RBD, a total resonance shift of about 200 picometers (“μm”) was achieved for an antibody concentration of 10 μg/mL. The data also showed a total resonance shift of about 50 pm for 1 μg/mL. The example biosensor 100 was then tested using convalescent serum samples of unknown antibody concentrations in the same manner. Serum samples were obtained from convalescent Covid-19 patients at least 14 days out of active disease, and acquired via the University of Rochester Medical Center's Healthy Donor protocol. Samples were processed and stored at −80° C. upon receipt, and then thawed and diluted prior to running the assays.

It should be appreciated that the use of an anti-FITC control resonator ring is important to measure nonspecific binding, as all samples produced non-negligible resonance shifts in these rings. The control ring also accounts for any changes in temperature over the course of the analysis. However, the response measured in the RBD rings was much higher in all convalescent samples.

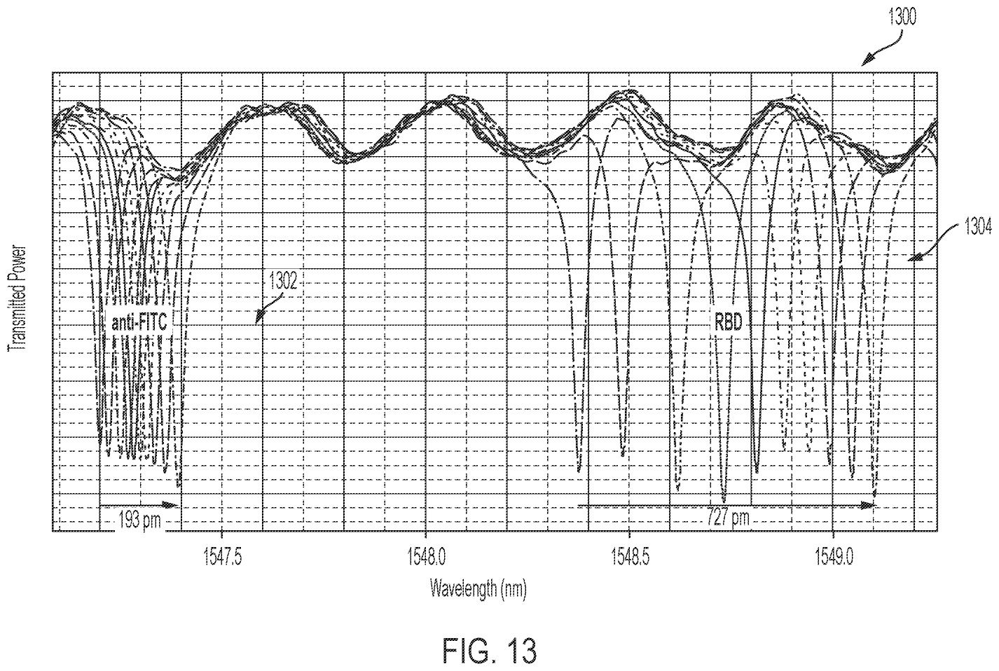

FIG. 13 shows a graph 1300 that is representative of sample spectra for a convalescent COVID-19 patient sample containing a high titer of anti-SARS-CoV-2 antibodies, as measured by the biosensor 100. The anti-FITC ring (represented by the left peak 1302) shifted about 200 pm over the course of ten minutes. By comparison, the SARS-CoV-2 RBD-functionalized ring (represented by the right peak 1304) shifted over 700 pm in this time. As shown in FIG. 13, each ring resonator has a corresponding resonant wavelength, at which there is a trough in transmitted power. With the addition of a sample containing anti-RBD antibodies, the right peak 1304 shifts as antibodies bind to the ring, while the anti-FITC ring 1302 shifts much less, due to nonspecific interactions with serum proteins. In other words, the SARS-CoV-2 RBD-functionalized ring of the detector element 212 accurately identified SARS-CoV-2 antibodies.

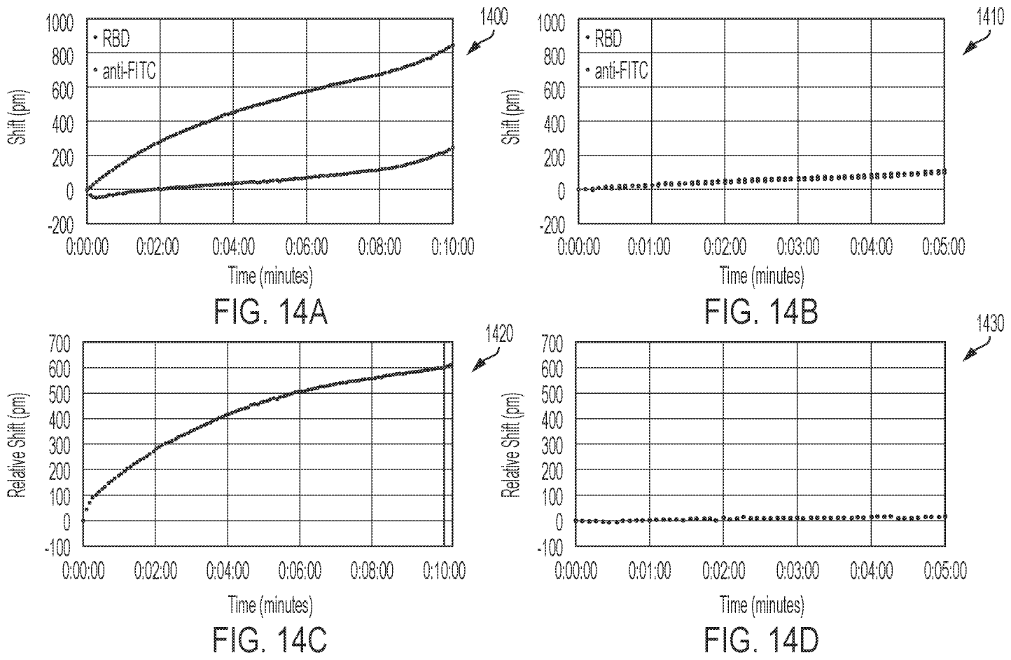

The data in the graph 1300 was analyzed using a Python script to create plots that show shifts in both the anti-FITC and RBD rings over time. The FITC-control shift was then subtracted to provide a relative shift binding curve. FIG. 14 shows graphs 1400, 1410, 1420, and 1430 that are representative of binding curves for both Covid-positive and -negative samples. Here the data is presented as the relative shift of RBD rings versus time.

The graphs 1400 and 1410 show resonant wavelength shift of control and test rings over time. The graph 1400 corresponds to a convalescent patient serum sample and the graph 1410 corresponds to a negative control. The graphs 1420 and 1430 correspond to the anti-FITC-subtracted response curves corresponding to the same respective samples. The response in the positive sample is apparent in the graphs 1400 and 1420, with the negative sample in graphs 1410 and 1430 showing almost no binding.

To compare the response of different samples, the shift after 1 and 5 minutes was recorded for each assay. While the choice of these time points is somewhat arbitrary, it was found that these were effective for understanding both the initial response (slope) of the assay and projected maximum shift. As shown in the graphs 1400 to 1430 of FIG. 14, signal continues to accumulate in both rings after the 5-minute time point. It was observed that the example photonic biosensor 100 disclosed herein reliably distinguishes positive from negative samples with an assay time of only one minute.

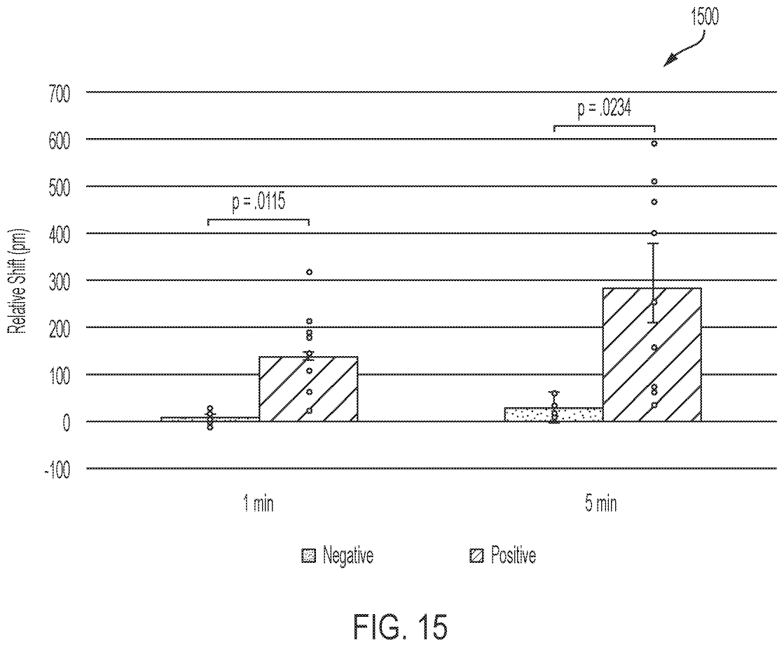

A comparison of relative shifts at 1 and 5 minutes for positive and negative samples is shown in FIG. 15. As shown in graph 1500 of FIG. 15, p values of 0.0115 and 0.0234 were obtained for 1- and 5-minute measurements, respectively, for discrimination between the two groups. These yield a sensitivity of 77.8% and a specificity of 100%, as there were no false positives. For the five-minute measurements, nine positive samples had an average relative shift of 283 pm, while five negative samples had an average of 29 pm. Only one positive sample had a shift less than any of the negative samples, and that sample had a relatively low concentration of anti-RBD antibodies (1.9 μg/mL), though not the lowest of the convalescent samples. Overall, the photonic biosensor 100 disclosed herein provides excellent discrimination between positive and negative samples, with a p value of 0.0115 at just one minute assay time.

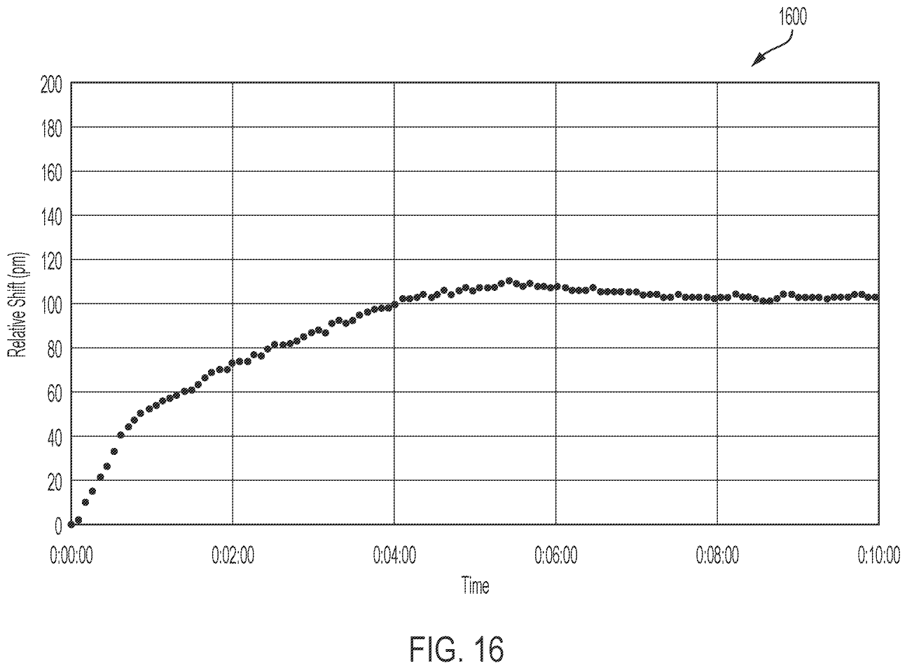

The results described above represent total antibody (total Ig) in a patient sample. To discriminate antibody class, it is necessary to incorporate a second step in which a secondary antibody (IgG, IgM, or IgA) is flowed over the PIC 104 of the biosensor 100. As provided below, the biosensor 100 was tested to determine its ability to detect IgG-specific signals. The biosensor 100 was tested by running experiments with a second step using an anti-IgG secondary label antibody. As the binding of a secondary antibody to the patient-derived antibodies increases the mass in close proximity to the sensor, this results in an additional resonance shift for the ring of the detection element 212. As described earlier, the biosensor 100 was washed with assay wash buffer, and then 10 μg/mL of anti-IgG in AWB was added. Because the AWB matrix contains no protein other than the label, the resulting binding curve yields an endpoint shift, as shown in the representative curve 1600 of FIG. 16. As shown, the shifts were generally between 100 and 150 pm. This data demonstrates that the photonic biosensor 100 can also be used to perform antibody isotype assessment assays to improve understanding about a patient's state of infection.

Of particular note is the speed with which these assays can be performed by the biosensor 100. With the biosensor 100 described herein, a patient's antibody status, and thus ideally immunity status, can be obtained within minutes, compared to hours or days for commercial antibody tests available for SARS-CoV-2. Positive vs. negative discrimination is achieved with p values of 0.0234 at 5 minutes and 0.0115 within just one minute. However, this is using processed serum rather than whole blood, and additional testing is needed to understand the ability of the biosensor 100 to utilize whole blood samples.

### CONCLUSION

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A photonic biosensor apparatus comprising:
a substrate including:
a sample addition zone in fluid communication with a wicking zone and a sample detection zone, wherein the sample detection zone is located between the sample addition zone and the wicking zone,
an optical input port disposed within or adjacent to the sample detection zone, wherein the optical input port is configured to optically couple to a light source, and
an optical output port disposed within or adjacent to the sample detection zone, wherein the optical output port is configured to optically couple to a light detector; and
a photonic integrated circuit disposed directly atop the substrate, wherein the photonic integrated circuit includes:
a first grating coupler aligned with the optical input port,
a second grating coupler aligned with the optical output port,
at least one waveguide located between the first grating coupler and the second grating coupler, and
at least one detection element disposed within the at least one waveguide.

2. The apparatus of claim 1, wherein the at least one detection element includes at least one capture molecule.

3. The apparatus of claim 1, wherein the at least one detection element includes at least one of a ring resonator, a double ring resonator, a cylindrical resonator, a spherical resonator, a spiral waveguide, photonic crystal, a Mach-Zehnder Interferometer (“MZI”), or combinations thereof.

4. The apparatus of claim 1, wherein the at least one waveguide includes a silicon nitride waveguide.

5. The apparatus of claim 1, wherein the photonic integrated circuit has a rectangular prism or cuboid shape.

6. The apparatus of claim 5, wherein the first grating coupler is disposed atop a first side of a face of the photonic integrated circuit, the second grating coupler is disposed atop a second, opposing side of the same face of the photonic integrated circuit, and the at least one detection element is positioned between the first side and the second side.

7. The apparatus of claim 6, wherein the photonic integrated circuit has a length between 2-20 millimeters (“mm”), a width between 0.25-10 mm, and a height between 0.1-5 mm.

8. The apparatus of claim 1, wherein the substrate further includes an enhancer zone or a conjugate zone in fluid communication with the detection zone and the sample addition zone, wherein the enhancer zone or the conjugate zone comprises at least one reagent for binding with the fluid sample.

9. The apparatus of claim 1, wherein the optical input port includes a first tunnel through the substrate and the optical output port includes a second tunnel through the substrate.

10. The apparatus of claim 9, wherein the first tunnel is located on a first side of a fluid pathway in the sample detection zone and the second tunnel is located on an opposite, second side of the fluid pathway in the sample detection zone.

11. The apparatus of claim 1, wherein the substrate further includes at least one of a cassette, a slide, or a test card.

12. The apparatus of claim 1, further comprising a light source and a photodetector that are included within a read head of at least one of a laboratory analyzer or a point-of-care (“PoC”) analyzer.

13. The apparatus of claim 1, further comprising a fluid pathway that fluidly couples the sample addition zone, the detection zone, and the wicking zone, wherein the fluid pathway includes micropillars or projections that are substantially vertical to the surface of the substrate and have a height, diameter, and reciprocal spacing such that lateral capillary flow of the fluid sample is achieved.

14. The apparatus of claim 13, wherein the height is between 1-1000 μm, the diameter is between 10-100 μm, and the reciprocal spacing between the micropillars is between 5-100 μm.

15. The apparatus of claim 1, wherein the detection zone is configured to provide at least one of fluorescence or colorimetric detection of one or more analytes within the fluid sample.

16. The apparatus of claim 1, wherein the photonic integrated circuit is connected to the substrate using at least one of a UV curable adhesive, physical stacking, or a tape/glue application.

17. The apparatus of claim 1, wherein the optical input port is a first optical input port, the optical output port is a first optical output port, and the photonic integrated circuit is a first photonic integrated circuit, and
wherein the substrate further includes:
a second optical input port located at another location of the sample detection zone and configured to optically couple to the light source, and
a second optical output port located at the other location of the sample detection zone and configured to optically couple to the light detector.

18. The apparatus of claim 17, further comprising a second photonic integrated circuit connected to the substrate at the other location, the second photonic integrated circuit including:
a first grating coupler aligned with the second optical input port;
a second grating coupler aligned with the second optical output port;
at least one waveguide between the first grating coupler and the second grating coupler; and
at least one detection element provided along the at least one waveguide and positioned to contact the fluid sample, when present, within the fluid pathway at the other location.

19. The apparatus of claim 18, wherein the at least one detection element of the first photonic integrated circuit is configured for the detection of a first analyte and the at least one detection element of the second photonic integrated circuit is configured for the detection of a second analyte.

20. A substrate comprising:
a sample addition zone in fluid communication with a wicking zone, and a sample detection zone, wherein the sample detection zone is between the sample addition zone and the wicking zone;
an optical input port disposed within the sample detection zone, wherein the optical input port is configured to optically couple to a light source;
an optical output port disposed within the sample detection zone, wherein the optical output port is configured to optically couple to a light detector; and
a photonic integrated circuit disposed directly atop the substrate, wherein the photonic integrated circuit comprises:
a first grating coupler aligned with the optical input port,
a second grating coupler aligned with the optical output port,
at least one waveguide between the first grating coupler and the second grating coupler, and
at least one detection element disposed within the at least one waveguide.

21. The substrate of claim 20, wherein the at least one detection element is positioned to contact a fluid sample, when present, within the sample detection zone.
